(19) United States
(12) Patent Application Publication
(10) Pub. No.: US 2006/0197804 A1
(43) Pub. Date: Sep. 7, 2006

(54) Electrostatic inkjet head

(76) Inventors: Jae-Seong Lim, Suwon-si (KR); Sung-Il Oh, Seoul (KR); Young-Jae Kim, Suwon-si (KR)

Correspondence Address: STANZIONE & KIM, LLP, 919 18TH STREET, N.W., SUITE 440, WASHINGTON, DC, 20006, US

(21) Appl. No.: 11/368,641

(22) Filed: Mar. 7, 2006

(30) Foreign Application Priority Data
Mar. 7, 2005 (KR) 2005-18505

(51) Int. Cl. B41J 2/06

(52) U.S. Cl. 347/55

(57) ABSTRACT

An electrostatic inkjet head and manufacturing method thereof are disclosed. With an electrostatic inkjet head, comprising a deformable diaphragm comprised in a face of an ink chamber, one or more first protrusions protruding from a face of the diaphragm, a structurally fixed electrode facing the diaphragm, and one or more second protrusions protruding from a face of the electrode towards the diaphragm, wherein the first protrusions and the second protrusions are arranged alternately so that their sides are in proximity with each other, the electrostatic force may be increased regardless of the distance between the diaphragm and the electrode, whereby the maximum displacement is increased by which the diaphragm may be deformed, as well as the ink discharge pressure, to allow the discharge of high-viscosity ink.

### CROSS-REFERENCE TO RELATED APPLICATIONS

This application claims the benefit of Korean Patent Application No. 2005-18505 filed with the Korea Intellectual Property Office on Mar. 7, 2005, the disclosure of which is incorporated herein by reference.

### BACKGROUND OF THE INVENTION

1. Field of the Invention

The present invention relates to a printer head, and in particular, to an electrostatic inkjet head and manufacturing method thereof.

2. Description of the Related Art

Typical operation types for inkjet printers include the bubble jet type and the piezoelectric type. The bubble jet type comprises a resistance heater, where the repeated rapid heating and cooling of the operation means cause damage to the resistance heater and lower the durability of the equipment. The piezoelectric type requires minute processing of the piezoelectric element, so that its manufacture is time-consuming and complicated, and entails a risk of decreased precision.

To solve the foregoing problems, the inkjet head is used which utilizes electrostatic force. The electrostatic inkjet head is applauded for its convenience in manufacturing, low power consumption, and simple operation principles, etc., and is widely used in a variety of devices that involve spraying ink to print an image.

The electrostatic inkjet head comprises a diaphragm, which forms a face of an ink chamber and discharges ink by its deformation, and an electrode facing the diaphragm, which generates electrostatic force. The electrostatic inkjet head operates by generating an electrical potential difference between the diaphragm and the electrode, so that the diaphragm is deformed by a predetermined amount of displacement due to electrostatic attraction, and removing the electrical potential difference, so that the ink within the ink chamber is discharged through the nozzle due to the force by which the diaphragm is restored.

In general, the diaphragm and the electrode of the electrostatic inkjet head are formed to have smooth surfaces. FIG. 1 is a cross sectional view of a conventional electrostatic inkjet head, and is FIG. 2 of U.S. Pat. No. 5,668,579. The structure and operation of the conventional electrostatic inkjet head will be described with reference to FIG. 1.

Ink droplets are sprayed from a nozzle 4 formed on an edge of the ink chamber 6, and the bottom of the ink chamber is formed by the diaphragm 5. The electrode 21 is positioned to face the diaphragm 5, and the gap G between the diaphragm 5 and the electrode 21 corresponds to the difference between the depth of the concave portion and the thickness of the electrode 21.

To describe its operation, when the diaphragm 5 and the electrode 21 are supplied with different electrical potentials, electrostatic force is generated due to the electrical potential difference. This electrostatic force creates an attraction between the diaphragm and the electrode plate, and since the electrode 21 is fixed, a deformation occurs on the thin diaphragm 5.

Later, when the electrical potentials supplied to the diaphragm 5 and electrode 21 are removed, the deformed diaphragm 5 is restored to its original position. Due to this restoration force of the diaphragm 5, the pressure inside the ink chamber 6 is increased, by which ink is discharged through the nozzle 4.

However, with the conventional electrostatic inkjet head, the distance between the two structural plates, i.e. the diaphragm and the electrode, must be sufficiently close for the electrostatic force to be generated. Therefore, the distance between the two structural plates becomes the maximum value of the displacement by which the diaphragm may be deformed, so that there is a limit to how great the displacement can be made for the conventional electrostatic inkjet head. In addition, closer distances between the two structural plates lead to a greater number of difficulties in the manufacturing process, with the occurrence of various problems such as insufficient pressure in discharging ink, etc.

Various attempts have been made to improve the discharge pressure of an electrostatic inkjet head, for example Korean patent grant no. 10-0242157 (“Electrostatic Inkjet Head”). In said invention, however, pressure is transferred to the diaphragm through the outer frame connected to the rotor, to result in a complicated structure and increases in manufacturing time and costs.

Another example is Japanese patent publication no. 2003-276194 (“Electrostatic Actuator, Liquid Drop Ejection Head, and Ink Jet Recorder”). Said invention comprises movable electrodes and fixed electrodes stacked alternately, and although the electrostatic force may be increased with the number of stacked electrodes, said invention is limited in that the surfaces facing each other in a pair of movable and fixed electrodes are not formed in a comb-pattern structure and do not create a displacement that is regardless of the distance between electrodes.

### SUMMARY OF THE INVENTION

The present invention provides an electrostatic inkjet head which allows a great electrostatic force regardless of the distance between the diaphragm and the electrode, whereby a large displacement may be created of the diaphragm and the ink discharge pressure may be increased.

Additional aspects and advantages of the present general inventive concept will be set forth in part in the description which follows and, in part, will be obvious from the description, or may be learned by practice of the general inventive concept.

One aspect of the invention provides an electrostatic inkjet head, comprising a deformable diaphragm comprised in a face of an ink chamber, one or more first protrusions protruding from a face of the diaphragm, a structurally fixed electrode facing the diaphragm, and one or more second protrusions protruding from a face of the electrode towards the diaphragm, where the first protrusions and the second protrusions are arranged alternately so that their sides are in proximity with each other.

It may be preferable for the first protrusions and the second protrusions to be formed in multiples to form comb-pattern structures, and the diaphragm and the electrode be positioned so that the multiple first protrusions and the multiple second protrusions mesh together without contact.

Preferably, the shortest distance between the first protrusions and the electrode or the shortest distance between the second protrusions and the diaphragm may be greater than the distance between the first protrusions and the second protrusions.

Preferably, the cross section of the first protrusions or the second protrusions in the direction of protrusion may be a rectangle. The first protrusions and the second protrusions may be of the same form. The first protrusions or the second protrusions may be formed as a multiple repetition of the same form. Also, the protruding lengths of the first protrusions may preferably decrease from the center portion of the diaphragm to the end portions.

It may be preferable for the first protrusions to protrude along an entire face of the diaphragm, or for the second protrusions to protrude along an entire face of the electrode. Also, the first protrusions may preferably protrude only from the center portion of the diaphragm, and the second protrusions may preferably protrude only from the center portion of the electrode in correspondence with the first protrusions.

One or more of the diaphragm, the first protrusions, the electrode, and the second protrusions may comprise single crystal silicon, and may preferably be produced by MEMS (Micro Electro Mechanical System) processes.

Another aspect of the invention provides an electrostatic inkjet head comprising an ink chamber having an ink nozzle at one end, an ink injection opening joined to the ink chamber, a deformable diaphragm comprised in a face of the ink chamber, one or more first protrusions protruding from a face of the diaphragm, a structurally fixed electrode facing the diaphragm, and one or more second protrusions protruding from a face of the electrode towards the diaphragm, where the first protrusions and the second protrusions are arranged alternately so that their sides are in proximity with each other.

Other aspects of the invention provide an ink cartridge comprising the electrostatic inkjet head, and an electrostatic inkjet printer comprising the ink cartridge and an operation circuit which supplies power to the electrode or the diaphragm.

Still another aspect of the invention provides a method of manufacturing an electrostatic inkjet head comprising (a) forming a PR coating layer on a silicon substrate used as an electrode or a diaphragm of an electrostatic inkjet head, (b) patterning a plurality of first protrusions or a plurality of second protrusions on the PR coating layer by lithography, (c) etching the silicon substrate to form comb-pattern first protrusions or second protrusions, (d) removing the PR coating layer, and (e) positioning the electrode and diaphragm manufactured by the forming (a) to the removing (d) to face each other, where the first protrusions and the second protrusions are made to form a comb-pattern structure, and the diaphragm and the electrode are positioned so that the first protrusions and the second protrusions mesh together without contact.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view of a conventional electrostatic inkjet head.

FIG. 2 is a magnified view of an electrostatic inkjet head according to a preferred embodiment of the invention.

FIG. 3 is a cross-sectional view of a diaphragm and an electrode of an electrostatic inkjet head according to a first preferred embodiment of the invention.

FIG. 4 is a cross-sectional view of a diaphragm and an electrode of an electrostatic inkjet head according to a second preferred embodiment of the invention.

FIG. 5 is a cross-sectional view of a diaphragm and an electrode of an electrostatic inkjet head according to a third preferred embodiment of the invention.

FIG. 6 is a cross-sectional view of an electrostatic inkjet head according to a preferred embodiment of the invention.

FIG. 7 is a flow diagram illustrating a manufacturing process of an electrostatic inkjet head according to a preferred embodiment of the invention.

FIG. 8 is a flowchart illustrating a manufacturing method of an electrostatic inkjet head according to a preferred embodiment of the invention.

### DETAILED DESCRIPTION OF THE PREFERRED EMBODIMENTS

Hereinafter, preferred embodiments of the electrostatic inkjet head and manufacturing method thereof according to the invention will be described in more detail with reference to the accompanying drawings. In the description with reference to the accompanying drawings, those components are rendered the same reference number that are the same or are in correspondence regardless of the figure number, and redundant explanations are omitted. Also, the basic principles will first be described before discussing the preferred embodiments of the invention.

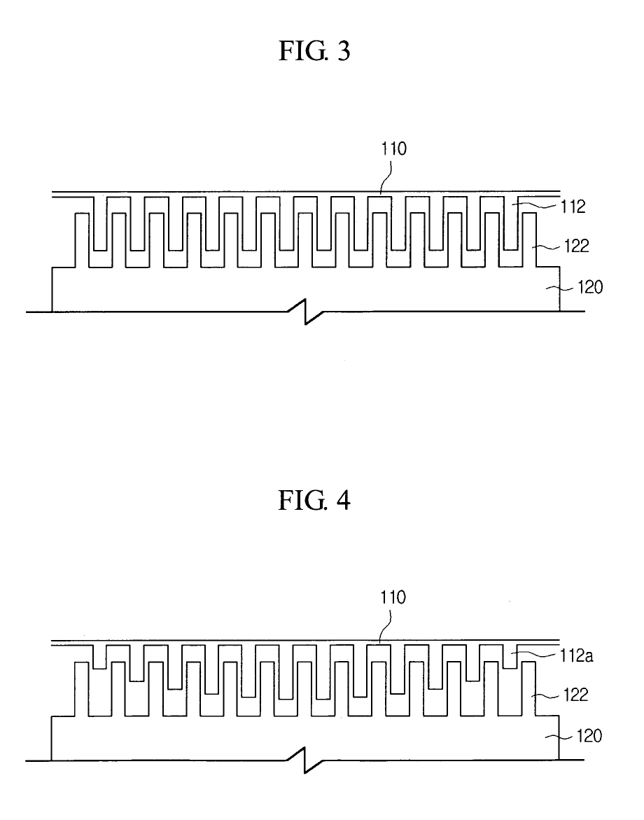

FIG. 2 is a magnified view of an electrostatic inkjet head according to a preferred embodiment of the invention, and FIG. 3 is a cross-sectional view of a diaphragm and an electrode of an electrostatic inkjet head according to a first preferred embodiment of the invention. In FIGS. 2 and 3 are illustrated a diaphragm 110, first protrusions 112, an electrode 120, and second protrusions 122.

This embodiment provides an electrostatic inkjet head with changed forms for the diaphragm and electrode, where the electrostatic force is generated, to allow a greater displacement of the diaphragm. That is, if the first protrusions 112 and second protrusions 122 are formed in a comb-pattern structure or a different form on the surfaces of the diaphragm 110 and the electrode 120, as shown in FIG. 2, the area is increased where electrostatic force is active, whereby the capacitance C is increased, and the electrostatic force is increased.

The following electrostatic force Fₑ as shown in Equation (1) is generated between a diaphragm and an electrode that are parallel to each other,

$${F}_{e} = \frac{1}{2} ( \frac{\partial C}{\partial x} {V}^{2} ) \qquad ( 1 )$$

wherein,

$$C = \frac{ɛ A}{d}$$

C: capacitance

ε: permittivity

A: area

d: distance

x: displacement

V: electrical potential difference

As in Equation (1), electrostatic force Fe is dependent on capacitance C when a constant electrical potential difference V is supplied, and since capacitance C is determined by area A and distance d, an increase in distance d leads to a decrease in electrostatic force Fₑ. Therefore, if the distance d between the diaphragm and the electrode is more than a few μm, the electrostatic force becomes too weak for the diaphragm to operate.

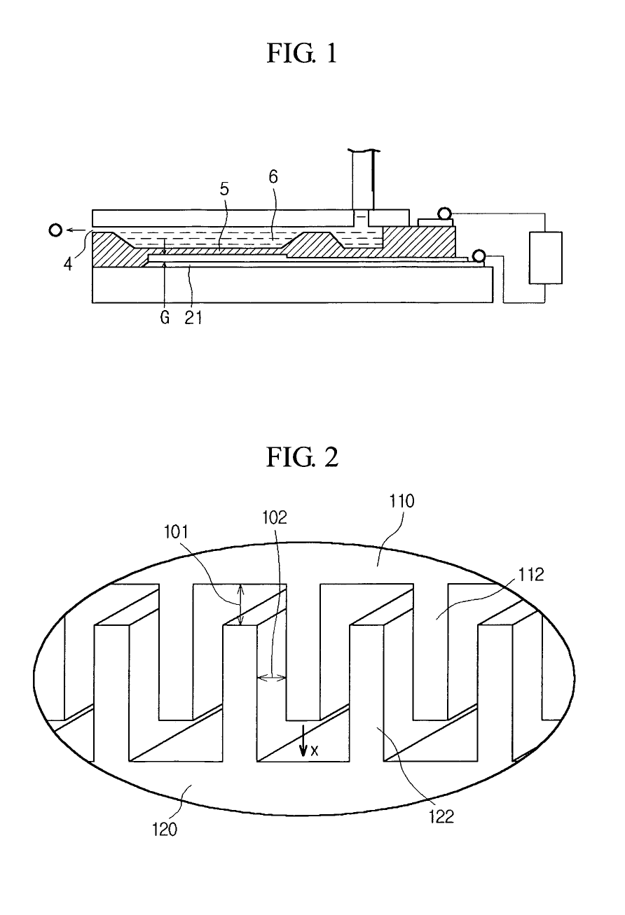

In a conventional inkjet head as shown in FIG. 1, with the electrode and the diaphragm formed as flat faces, the electrostatic force Fe required to obtain a certain displacement (G of FIG. 1) decreases as the displacement increases. However, in the inkjet head of the present invention, the protrusions 112, 122 are formed in a comb-pattern structure or a different form to increase the cross-sectional area where electrostatic force is active.

Since the electrostatic force in the direction of protrusion is negligible in the present embodiment when the distance 101 between the diaphragm 110 and the electrode 120 is sufficiently greater than the gap 102 between protrusions, it may be said that the electrostatic force is unrelated to the distance 101. In other words, the displacement x may be adjusted according to the electrical potential difference V regardless of the distance 101, and the distance 101 between the diaphragm 110 and electrode 120 may be designed to be greater, so that the displacement x may be increased.

Therefore, it is advantageous to form the first protrusions 112 and second protrusions 122 such that the distances between their sides, i.e. the interposing gaps, are sufficiently small, in which case the distance between the diaphragm 110 and the electrode 120, more specifically the distance between the first protrusions 112 and the electrode 120 or the distance between the second protrusions 122 and the diaphragm 110, becomes less important than in the conventional head structure which has two flat faces facing each other. This allows easier manufacturing, and improved reliability in the operation of the head.

Although the effects of this embodiment may be obtained by forming one or more first protrusions 112 and second protrusions 122 arranged with their sides in proximity to each other, it is preferable that the protrusions be formed in multiples so as to form a comb-pattern structure.

In other words, forming multiple first protrusions 112 and second protrusions 122 on the diaphragm 110 and electrode 120 and meshing the comb-pattern structured first protrusions 112 and second protrusions 122, in the same manner as gears are meshed, maximizes the area where the electrostatic force is active in the diaphragm 110 and electrode 120, as discussed above, to most efficiently utilize the effects of the invention.

Of course, when arranging the two comb-pattern structures to be meshed with each other, the two structures must be electrically disconnected, i.e. insulated, so that electrostatic force may be generated.

Since electrostatic force is generated in an inkjet head according to the present invention regardless of the distance between the diaphragm 110 and the electrode 120, said distance can be made to be sufficiently great to maximize the displacement by which the diaphragm 110 is deformed.

As described above, since the gap between the first protrusions 112 and the second protrusions 122 is important in the present embodiment, the distance between the diaphragm 110 and the electrode 120, i.e. the shortest distance between the first protrusions 112 and the electrode 120 or the shortest distance between the second protrusions 122 and the diaphragm 110 can be made to be greater than the gap between the first protrusions 112 and the second protrusions 122.

Typically, when the thickness and gaps of the protrusions are a few μm, an equal or greater value may be given for the distance between the diaphragm 110 and the electrode 120 (the shortest distance). Thus, the distance between the diaphragm 110 and the electrode 120 can be increased to maximize the displacement of the diaphragm 110, so that consequently the ink discharge pressure may be increased.

It is preferable that the cross sections of the first protrusions 112 and second protrusions 122 in the directions of protrusion be rectangular. However, the present invention is not to be limited to rectangular cross sections for the protrusions, and those shapes such as triangular, trapezoidal, semi-circular, elliptical, and bell-shaped shapes, etc., may obviously be included which can maximize the area to increase electrostatic force.

However, since the diaphragm 110 is a member that is subject to deformation by electrostatic force, a rectangular shape is preferable over other shapes that may cause mechanical problems in the deformation process. Further, since the invention utilizes electrostatic force generated between two parallel electrodes facing each other, a rectangular shape is preferable, with which the largest area of parallel faces facing each other may be obtained, over other shapes such as triangular or trapezoidal shapes, with which the gaps between protrusions may vary.

Also, forming the cross sections of the protrusions as rectangles is also efficient in the manufacturing of the diaphragm 110 and electrode 120 of the present embodiment by etching. The first protrusions 112 or the second protrusions 122 are each formed in multiples, while it is not necessary for each to have the same form. That is, the forms of the protrusions may differ for those on the center portion and on the end portions of the diaphragm 110 or the electrode 120, and a variety of forms may be utilized to obtain greater electrostatic forces.

However, it may be preferable for the each protrusion to be formed as a repetition of the same form for convenience in their design and manufacture. The first protrusions 112 and the second protrusions 122 may also differ in form, but as described above, it may be preferable for the first protrusions 112 and the second protrusions 122 to be the same for convenience in design and manufacture.

FIG. 4 is a cross-sectional view of a diaphragm and an electrode of an electrostatic inkjet head according to a second preferred embodiment of the invention. In FIG. 4 are illustrated a diaphragm 110, first protrusions 112a, an electrode 120, and second protrusions 122.

In an electrostatic inkjet head of the present invention, when an electrical potential difference is supplied to the diaphragm 110 and the electrode 120, the diaphragm 110 is bent towards the electrode 120 due to the electrostatic attraction towards the electrode 120. Here, the deformation of the first protrusions varies depending on whether they are formed on the center portion or end portions of the diaphragm 110.

That is, when the diaphragm 110 is deformed to bend towards the electrode 120, the first protrusions 112a formed on the center portion are made only to move towards the electrode 120, while the first protrusions 112a formed on the end portions are made to rotate outward. Although the degree of rotation of the first protrusions 112a may be minimal when the displacement of the diaphragm 110 is small, the degree of rotation of the first protrusions 112a increases also as the displacement increases.

Therefore, those cases may occur wherein the first protrusions 112a formed on the end portions come into contact with the second protrusions 122, as a consequence of the deformation of the diaphragm 110. When the first protrusions 112a contact the second protrusions 122, they may become electrically connected so that the electrostatic force may not be generated, or when they are electrically insulated by means of coatings, etc., the mechanical resistance may restrict the degree of deformation of the diaphragm 110.

To prepare for such occurrences, the protruding lengths of the first protrusions 112a are made to decrease from the center portion to the end portions. Thus, even when the first protrusions 112a are made to rotate outward at the end portions, they will not come into contact with the second protrusions 122. Of course, the first protrusions 112a of the end portions must be protruded to a degree such that their sides are in proximity with the second protrusions 122 for the electrostatic force to be generated.

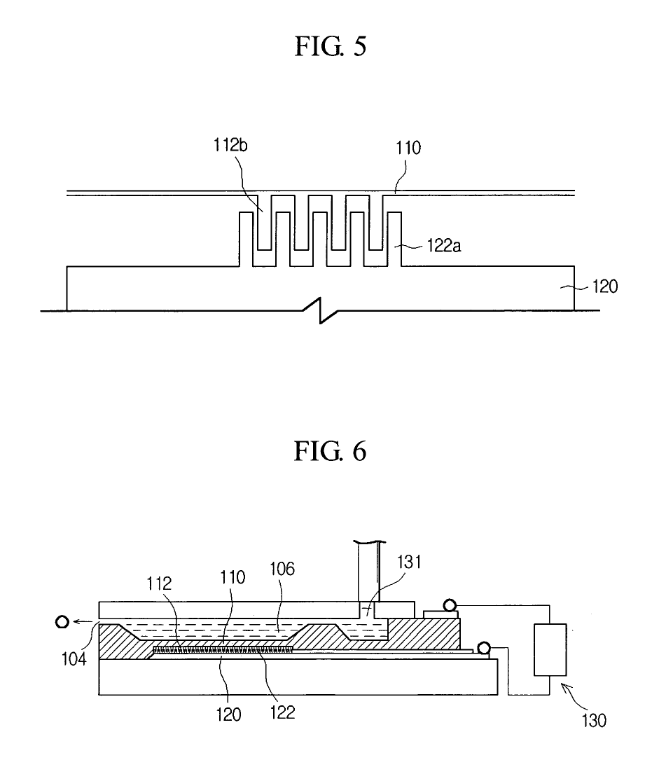

FIG. 5 is a cross-sectional view of a diaphragm and an electrode of an electrostatic inkjet head according to a third preferred embodiment of the invention. In FIG. 5 are illustrated a diaphragm 110, first protrusions 112b, an electrode 120, and second protrusions 122a.

Whereas the second embodiment varied the sizes of the first protrusions 112a on the premise that the protrusions are formed along the entire diaphragm 110 or electrode 120, the same problem may be solved as for the second embodiment by forming the first protrusions 112b only on the center portion. In this case, it is preferable that the second protrusions 122a also be formed only on the center portion in correspondence with the first protrusions 112b.

The third embodiment can solve the problem of contact between protrusions due to the deformation of the diaphragm 110. However, there is a possibility that the maximum displacement by which the diaphragm 110 may be deformed may not be achieved due to the decrease in area where the electrostatic force is active.

Therefore, to obtain a sufficiently great electrostatic force regardless of the distance between the diaphragm 110 and the electrode 120, it may be preferable for the first protrusions to protrude along the entire face of the diaphragm 110 and for the second protrusions 122 to protrude along the entire face of the electrode 120. It may further be preferable that the first protrusions be reduced in size or the first protrusions not be formed at all where there may be problems due to the deformation of the diaphragm 110, based on the required amount of displacement for the necessary ink discharge pressure.

The diaphragm 110 and the first protrusions 112, as well as the electrode 120 and the second protrusions 122 may respectively be formed as a single body, preferably manufactured from single crystal silicon. However, the invention is not limited to such materials for the diaphragm 110 and electrode 120, and it is apparent that other materials may be used, which satisfy the electrical and mechanical properties capable of providing the effects of the invention, within a scope obvious to those skilled in the art.

Further, the diaphragm 110 and electrode 120, etc., having protrusions of the present invention may preferably be manufactured by MEMS (microelectromechanical system) processes. MEMS is a technology of producing electromechanical elements at a microscopic scale, invisible to the human eye, and is used in applications of virtually all fields where microscopic mechanical compositions are produced.

MEMS technology is an application of micro processing technology to the manufacture of micro sensors or actuators and electromechanical compositions of microscopic scale, and is a form of micro processing technology applying conventional semiconductor processes, especially integrated circuit technology. A micro machine manufactured by MEMS may achieve an accuracy of below the μm scale. Since the diaphragm 110 and electrode 120 of the present invention have sizes of μm scale, and since they are parts operated mechanically by electrostatic force, it is preferable that they be manufactured by the above-mentioned MEMS processes.

However, the manufacturing process for the diaphragm 110 and electrode 120 of the invention is not limited to MEMS, and it is apparent that all manufacturing processes may be used that can provide the effects of the invention within a scope obvious to those skilled in the art.

FIG. 6 is a cross-sectional view of an electrostatic inkjet head according to a preferred embodiment of the invention. In FIG. 6 are illustrated an ink nozzle 104, an ink chamber 106, a diaphragm 110, first protrusions 112, an electrode 120, second protrusions 122, an operation circuit 130, and an ink injection opening 131.

The present invention provides an electrostatic inkjet head in which the shapes of the diaphragm 110 and the electrode 120 have been changed, and the scope of the invention includes an inkjet head in which the diaphragm 110 and the electrode 120 are applied, as well as an ink cartridge and inkjet printer in which the inkjet head is used.

Thus, to describe the structure of the inkjet head of the present invention with reference to FIG. 6, the diaphragm 110, on which is formed the first protrusions 112 set forth above, is mounted on the bottom face of the ink chamber 106 comprising the ink nozzle 104 for spraying ink and the ink injection opening 131 for supplying ink. The electrode 120, on which the second protrusions 122 are formed facing the first protrusions 112, is positioned opposite to the diaphragm 110.

The diaphragm 110 and the electrode 120 are connected to the operation circuit 130 to supply an electrical potential difference. When an electrical potential difference is supplied to the diaphragm 110 and the electrode 120 by the operation circuit 130, an electrostatic attraction is generated between the diaphragm 110 and electrode 120, and since both ends of the diaphragm 110 are fixed to the bottom face of the ink chamber 106, the diaphragm 110 is deformed towards the electrode 120.

When the diaphragm 110 is deformed towards the electrode 120, the volume of the ink chamber 106 is increased, whereby ink is injected through the ink injection opening 131 into the ink chamber 106.

When the electrical potential difference supplied by the operation circuit 130 is removed, the deformed diaphragm 110 is restored to its original position, and as this decreases the volume of the ink chamber 106, ink is sprayed from the ink chamber 106 through the ink nozzle 104.

In this embodiment, the comb-pattern structured first protrusions 112 and second protrusions 122 are formed respectively on the diaphragm 110 and the electrode 120 and the area is increased where electrostatic force is active, so that an equal amount of electrical potential difference supplied by the operation circuit 130 generates a greater electrostatic force. Thus, the diaphragm 110 is deformed to a greater degree, and a greater pressure is applied to the ink chamber 106 when the diaphragm 110 is restored.

When the pressure applied to the ink chamber 106 is increased, a greater amount of ink may be sprayed, or high-viscosity ink may be used which would not have been possible in prior art due to the limit of electrostatic force. If, on the other hand, a lower pressure is desired on the ink chamber 106 to spray a small amount of ink or to spray low-viscosity ink, one needs only to adjust the electrical potential difference, etc., supplied by the operation circuit 130 to decrease the electrostatic force.

Therefore, the ink cartridge and inkjet printer using the inkjet head set forth above provide improved applicability, since a greater amount of ink may be sprayed or high-viscosity ink may be used for printing. Of course, when a smaller amount of ink or low-viscosity ink is to be used, the electrical potential difference, etc., may be adjusted, so that no problems in usage occur.

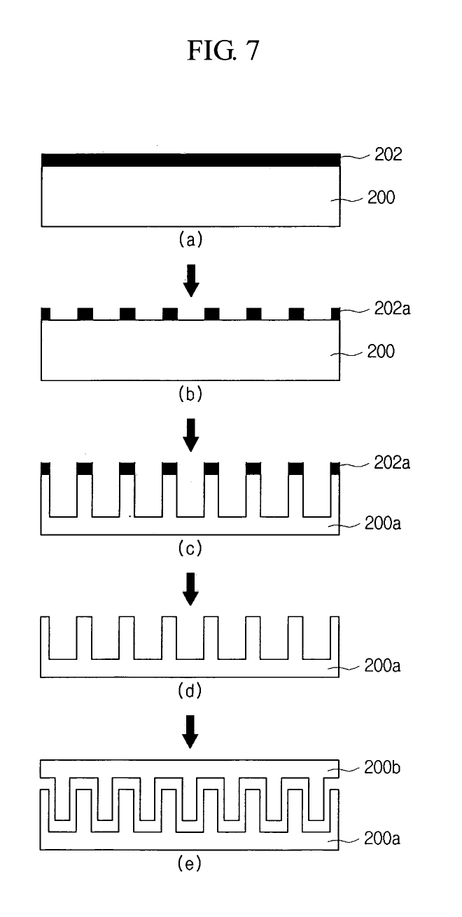

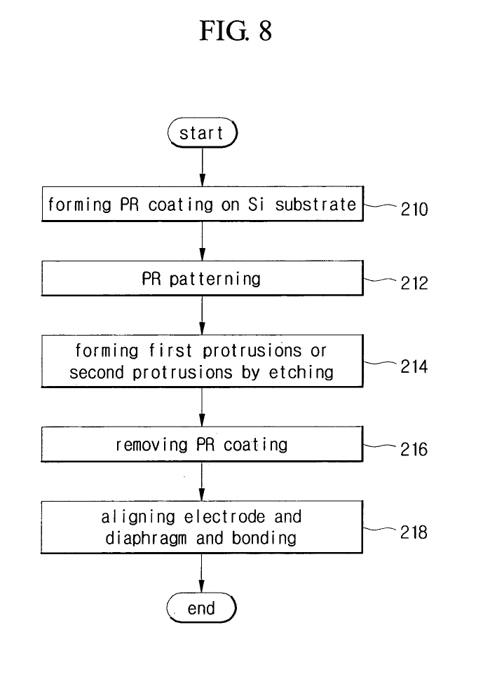

FIG. 7 is a flow diagram illustrating a manufacturing process of an electrostatic inkjet head according to a preferred embodiment of the invention, and FIG. 8 is a flowchart illustrating a manufacturing method of an electrostatic inkjet head according to a preferred embodiment of the invention. Referring to FIG. 7, a silicon substrate 200 and a PR coating layer 202 are illustrated.

As discussed above, the diaphragm and electrode of the present invention may be manufactured with convenience and precision using MEMS technology. To explain the manufacturing process of an electrostatic diaphragm and electrode according to the present embodiment, a PR coating layer 202 is first formed on the silicon substrate 200 which will be used as the electrode or diaphragm ((a) of FIG. 7).

A pattern 202a is formed on the PR coating layer for the first protrusions or second protrusions ((b) of FIG. 7), where techniques apparent to those skilled in the art, such as lithography, may be used for the PR patterning.

Comb-shaped first protrusions or second protrusions are formed according to the pattern formed by etching the silicon substrate 200a ((c) of FIG. 7), where etching methods apparent to those skilled in the art, such as dry etching, may be used.

After the etching is completed and the first protrusions or second protrusions are formed, the remaining PR coating layer 202a is removed ((d) of FIG. 7). The diaphragm 200b and the electrode 200a thus produced are aligned and bonded such that the first protrusions and second protrusions mesh with each other ((e) of FIG. 7).

The manufacturing method of an inkjet head using the preferred processing method as described above and based on MEMS technology may be represented as a flowchart as in FIG. 8, comprising: forming a PR coating on the silicon substrate (210), forming a PR pattern by lithography (212), etching the first protrusions or second protrusions to a required thickness by dry etching (214), removing the remaining PR coating layer (216), and aligning and bonding the two structural plates after the diaphragm and the electrode are produced (218).

Although the comb-shaped structure of the diaphragm and electrode as described above presupposes a so-called “Side Shooter” type inkjet head, where the spraying direction of the ink droplets and the vibration direction of the diaphragm are perpendicular, the inkjet head of the present invention is not limited to such operational type, and it is apparent that other operational types may be used, in which the comb-pattern structures of the diaphragm and electrode may be applied, such as the so-called “Face Shooter” type, where the spraying direction of the ink droplets and the vibration direction of the diaphragm are the same, as in a syringe, within a scope obvious to those skilled in the art.

According to the present invention comprised as above, protrusions are formed on the surfaces of the diaphragm and the electrode in a comb-pattern or a different pattern to increase the area where the electrical field is created, so that the electrostatic force may be increased regardless of the distance between the diaphragm and the electrode, whereby the maximum displacement is increased by which the diaphragm may be deformed, and it is possible to control the displacement according to electrical potential difference. Moreover, since the maximum displacement of the diaphragm is increased, the ink discharge pressure may also be increased, to allow the discharge of high-viscosity ink.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electrostatic inkjet head, comprising:
a deformable diaphragm comprised in a face of an ink chamber;
one or more first protrusions protruding from a face of the diaphragm;
a structurally fixed electrode facing the diaphragm; and
one or more second protrusions protruding from a face of the electrode towards the diaphragm;
wherein the first protrusions and the second protrusions are arranged alternately so that their sides are in proximity with each other.

2. The electrostatic inkjet head of claim 1, wherein the first protrusions and the second protrusions are formed in multiples to form comb-pattern structures, and the diaphragm and the electrode are positioned so that the multiple first protrusions and the multiple second protrusions mesh together without contact.

3. The electrostatic inkjet head of claim 1, wherein the shortest distance between the first protrusions and the electrode or the shortest distance between the second protrusions and the diaphragm is greater than the distance between the first protrusions and the second protrusions.

4. The electrostatic inkjet head of claim 1, wherein the cross section of the first protrusions or the second protrusions in the direction of protrusion is a rectangle.

5. The electrostatic inkjet head of claim 1, wherein the first protrusions and the second protrusions are of the same form.

6. The electrostatic inkjet head of claim 1, wherein the first protrusions or the second protrusions are formed as a multiple repetition of the same form.

7. The electrostatic inkjet head of claim 1, wherein the protruding lengths of the first protrusions decrease from the center portion of the diaphragm to the end portions.

8. The electrostatic inkjet head of claim 1, wherein the first protrusions protrude along an entire face of the diaphragm, or the second protrusions protrude along an entire face of the electrode.

9. The electrostatic inkjet head of claim 1, wherein the first protrusions protrude only from the center portion of the diaphragm, and the second protrusions protrude only from the center portion of the electrode in correspondence with the first protrusions.

10. The electrostatic inkjet head of claim 1, wherein one or more of the diaphragm, the first protrusions, the electrode, and the second protrusions comprise single crystal silicon.

11. The electrostatic inkjet head of claim 1, wherein one or more of the diaphragm, the first protrusions, the electrode, and the second protrusions are produced by MEMS (Micro Electro Mechanical System) processes.

12. An electrostatic inkjet head, comprising:
an ink chamber having an ink nozzle at an end thereof;
an ink injection opening joined to the ink chamber;
a deformable diaphragm comprised in a face of the ink chamber;
one or more first protrusions protruding from a face of the diaphragm;
a structurally fixed electrode facing the diaphragm; and
one or more second protrusions protruding from a face of the electrode towards the diaphragm;
wherein the first protrusions and the second protrusions are arranged alternately so that their sides are in proximity with each other.

13. An ink cartridge comprising the electrostatic inkjet head of claim 12.

14. An electrostatic inkjet printer, comprising:
the ink cartridge of claim 13; and
an operation circuit which supplies power to the electrode or the diaphragm.

15. A method of manufacturing an electrostatic inkjet head, comprising:
(a) forming a PR coating layer on a silicon substrate used as an electrode or a diaphragm of an electrostatic inkjet head;
(b) patterning a plurality of first protrusions or a plurality of second protrusions on the PR coating layer by lithography;
(c) etching the silicon substrate to form comb-pattern first protrusions or second protrusions;
(d) removing the PR coating layer; and
(e) positioning the electrode and diaphragm manufactured by the forming (a) to the removing (d) to face each other,
wherein the first protrusions and the second protrusions are made to form a comb-pattern structure, and the diaphragm and the electrode are positioned so that the first protrusions and the second protrusions mesh together without contact.
